(19) United States
(12) Patent Application Publication
(10) Pub. No.: US 2019/0212930 A1
(43) Pub. Date: Jul. 11, 2019

(54) Data storage chip and data access method

(71) Applicant: REALTEK SEMICONDUCTOR CORPORATION, HSINCHU (TW)

(72) Inventors: ZHENBING QIAN, Jiangsu Province (CN); DONG-YU HE, Jiangsu Province (CN); XIN YIN, Jiangsu Province (CN); ZHAOCHI LIU, Jiangsu Province (CN); HONG-HAI DAI, Jiangsu Province (CN)

(21) Appl. No.: 16/223,877

(22) Filed: Dec. 18, 2018

Related U.S. Application Data
(60) Provisional application No. 62/615,463, filed on Jan. 10, 2018.

(30) Foreign Application Priority Data
Jan. 17, 2018 (CN) 201810044388.3

(51) Int. Cl. G06F 3/06

(52) U.S. Cl. CPC G06F 3/0622; G06F 3/0673; G06F 3/0659

(57) ABSTRACT

This invention discloses a data storage chip and a data access method. The data access method is applied to a memory that includes a first area having a first range of memory address and a second area having a second range of memory address. The first range of memory address and the second range of memory address do not overlap. The method includes steps of: reading a predetermined address of the first area to obtain a control value; receiving a memory read command containing a target address; accessing the first area according to the memory read command when the target address is within the first range of memory address, and accessing the second area according to the memory read command when the target address is within the second range of memory address; and selectively sending the data read from the first area according to the control value.

### BACKGROUND OF THE INVENTION

### 1. Field of the Invention

The present invention generally relates to a memory, and, more particularly, to a data storage chip and a data access method.

### 2. Description of Related Art

FIG. 1 shows a schematic diagram of a conventional off-chip storage scheme. The chip 110 includes a microcontroller 112 and a memory controller 114, and a memory 120 is arranged outside the chip 110. The microcontroller 112 accesses the memory 120 through the memory controller 114. The memory controller 114 writes data to a specified memory address or reads data from a specified memory address according to an access command (including a read/write command and a memory address) from the microcontroller 112. In general, the microcontroller 112 has full access to the data in the memory 120. In such a configuration, the data in the memory 120 is subject to theft as a malicious person may: (1) detach the memory 120 and then directly access it to obtain the stored data; or (2) tamper with the software executed by the microcontroller 112 and then obtain the data in the memory 120 through the memory controller 114. Due to its lack of security, the conventional off-chip storage scheme is not suitable for storing confidential data. Therefore, it is necessary to provide a more secure data storage mechanism.

### SUMMARY OF THE INVENTION

In view of the issues of the prior art, an object of the present invention is to provide a data storage chip and a data access method for data security improvement.

A data storage chip is provided. The data storage chip includes a memory, a computing circuit, and a memory. The memory has a first area and a second area. The first area has a first range of memory address, the second area has a second range of memory address, the first area and the second area are different logic areas of the memory, and the first range of memory address does not overlap with the second range of memory address. The computing circuit is configured to send a memory access command that includes a target address. The memory controller is coupled to the computing circuit and the memory and is configured to access the first area or the second area of the memory according to the memory access command. When the target address is within the first range of memory address, the memory controller selectively accesses the first area according to a control value. When the target address is within the second range of memory address, the memory controller accesses the second area. The memory, the computing circuit, and the memory controller are packaged in a single chip.

A data storage chip is also provided. The data storage chip includes a memory, a computing circuit, and a memory controller. The memory has a first area and a second area. The first area has a first range of memory address, the second area has a second range of memory address, the first area and the second area are different logic areas of the memory, and the first range of memory address does not overlap with the second range of memory address. The computing circuit is configured to send a memory access command that includes a target address. The memory controller is coupled to the computing circuit and the memory and is configured to access the first area or the second area of the memory according to the memory access command. The memory controller includes a first control module, a second control module, and a data selection module. The first control module accesses the first area but does not access the second area. The second control module accesses the second area but does not access the first area. The data selection module is coupled to the first control module and is configured to selectively send the data in the first area to the computing circuit according to a control value. The first control module accesses the first area according to the memory access command when the target address is within the first range of memory address, and the second control module accesses the second area according to the memory access command when the target address is within the second memory. The memory, the computing circuit, and the memory controller are packaged in a single chip.

A data access method is also provided. The data access method is applied to a memory that has a first area and a second area. The first area has a first range of memory address, the second area has a second range of memory address, the first area and the second area are different logic areas of the memory, and the first range of memory address does not overlap with the second range of memory address. The method includes steps of: reading a predetermined address of the first area to obtain a control value; receiving a memory read command that contains a target address; accessing the first area according to the memory read command when the target address is within the first range of memory address, and accessing the second area according to the memory read command when the target address is within the second range of memory address; and selectively sending the data read from the first area according to the control value.

According to the data storage chip and the data access method of the present invention, a memory is divided into a security area and a non-security area, and separate control modules and control logics are utilized for the access control of the memory areas. Compared with the prior art, the present invention can effectively prevent the theft of confidential or sensitive data.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 illustrates a schematic diagram of a conventional off-chip storage scheme.

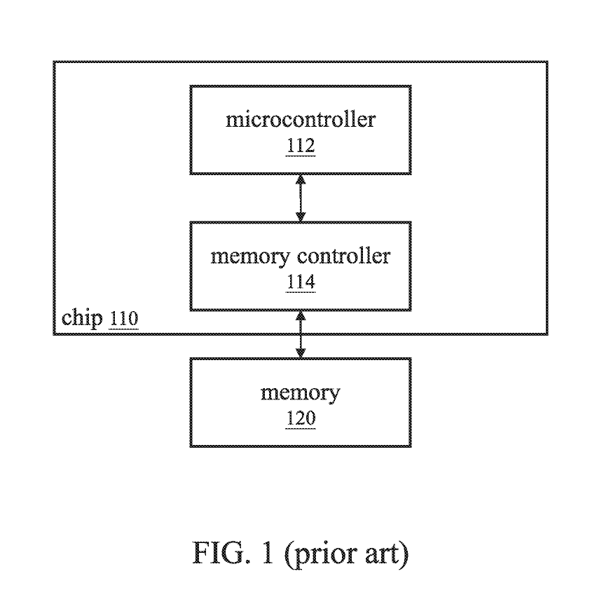

FIG. 2 illustrates a functional block diagram of a data storage chip according to an embodiment of the present invention.

FIG. 3 illustrates a functional block diagram of a data storage chip according to another embodiment of the present invention.

FIG. 4 illustrates a flowchart of a data access method according to an embodiment of the present invention.

FIG. 5 illustrates a flowchart of a data access method according to another embodiment of the present invention.

### DETAILED DESCRIPTION OF THE EMBODIMENTS

The following description is written by referring to terms of this technical field. If any term is defined in this specification, such term should be explained accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a data storage chip and a data access method. On account of that some or all elements of the data storage chip could be known, the detail of such elements is omitted provided that such detail has little to do with the features of this disclosure and this omission nowhere dissatisfies the specification and enablement requirements. Some or all of the processes of the data access method may be implemented by software and/or firmware and can be performed by the data storage chip or its equivalent. A person having ordinary skill in the art can choose components or steps equivalent to those described in this specification to carry out the present invention, which means that the scope of this invention is not limited to the embodiments in the specification.

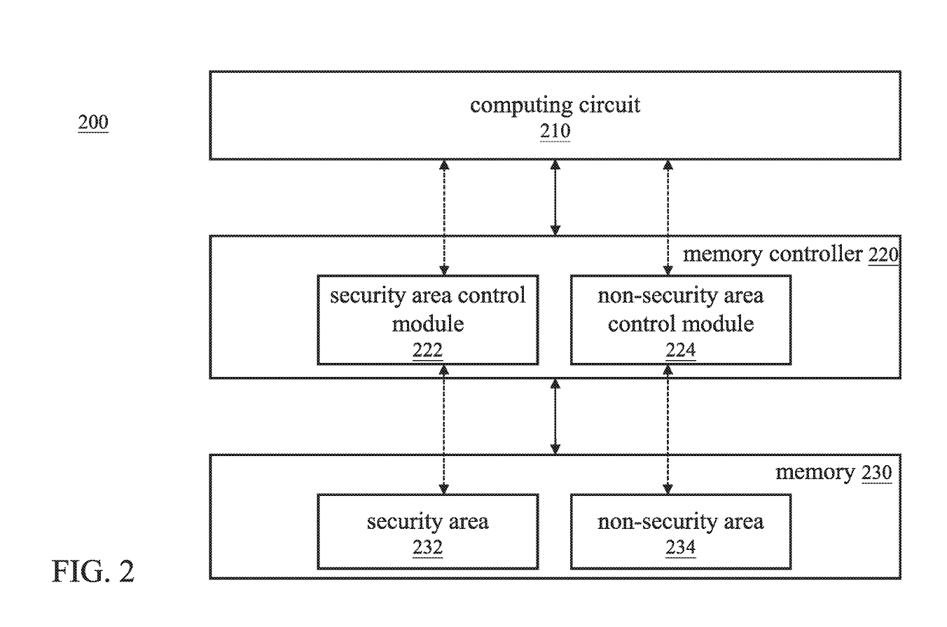

FIG. 2 is a functional block diagram of a data storage chip according to an embodiment of the present invention. In the figure, physical communication and data transmission are indicated by solid lines, and logical communication and data transmission are indicated by broken lines. The data storage chip 200 includes a computing circuit 210, a memory controller 220, and a memory 230. The computing circuit 210 may be a circuit having a program execution capability, including, but not limited to, a micro control unit (MCU), a microcontroller, a central processing unit (CPU), etc. The memory 230 is logically divided into two areas: a security area 232 and a non-security area 234. The security area is the protected area, and access to the data stored therein is restricted. The non-security area is an unprotected area or a normal area, and access to data stored therein is not restricted. The security area 232 has a first range of memory address, the non-security area 234 has a second range of memory address, and the first range of memory address does not overlap with the second range of memory address. In other words, the security area 232 and the non-security area 234 are different logic areas of the memory 230. The memory controller 220 includes a security area control module 222 and a non-security area control module 224. The computing circuit 210 accesses the security area 232 through the security area control module 222 and accesses the non-security area 234 through the non-security area control module 224. The computing circuit 210, the memory controller 220, and the memory 230 are packaged in the same chip or a single chip which has a data storage function.

When the computing circuit 210 needs to access the memory 230, the computing circuit 210 sends out a memory access command containing a target address. The memory access command contains a write command or a read command. Depending on whether the memory access command contains the write command or the read command, the memory controller 220 either writes the data to the target address or reads the data from the target address and then transmits the read data to the computing circuit 210. When accessing the memory 230, the memory controller 220 determines, according to the target address in the memory access command, whether to use the security area control module 222 to access the security area 232 or to use the non-security area control module 224 to access the non-security area 234. More specifically, when determining that the target address is within the first range of memory address, the memory controller 220 uses the security area control module 222 to access the security area 232; when, on the other hand, determining that the target address is within the second range of memory address, the memory controller 220 uses the non-security area control module 224 to access the non-security area 234. In some embodiments, the security area control module 222 and the non-security area control module 224 substantially correspond to or use the same circuit but have different control logics. In other embodiments, the security area control module 222 and the non-security area control module 224 substantially correspond to or use different circuits.

The security area control module 222 determines whether to access the security area 232 according to the memory access command and a control value, while the non-security area control module 224 determines whether to access the non-security area 234 according to the memory access command but not the control value. The control value is, for example, a register value of a certain register of the memory controller 220. For example, when the control value is a first value (e.g., 1 or 0xFF), the security area control module 222 accesses the security area 232 according to the memory access command; when the control value is a second value (the second value is different from the first value, such as 0 or 0x00), the security area control module 222 does not or is not allowed to access the security area 232. That is, the memory controller 220 (specifically, the security area control module 222) selectively accesses the security area 232 according to the control value, whereas the memory controller 220 (specifically, the non-security area control module 224) accesses the non-security area 234 according to the memory access command without referring to the control value. In other words, the memory controller 220 (specifically, the security area control module 222) has restricted access to the security area 232, and the memory controller 220 (specifically, the non-security area control module 224) has unrestricted accesses to the non-security area 234.

By dividing the memory 230 into the security area 232 and the non-security area 234 and imposing restriction on the access right to one of the two areas, the protection of confidential data or sensitive data can be realized. Since the range of memory address corresponding to the security area 232 and the rule of setting the control value are not known to a malicious person, that person cannot steal the confidential data in the memory 230 by tampering with the software executed by the computing circuit 210. Moreover, since the memory 230 is packaged in the same chip as the computing circuit 210 and the memory controller 220, separating the memory 230 from the chip will damage the memory 230, which makes it impossible for a malicious person to forcibly separate the memory 230 from the chip to thereby treat the memory 230 as a stand-alone device in an attempt to access the data stored therein.

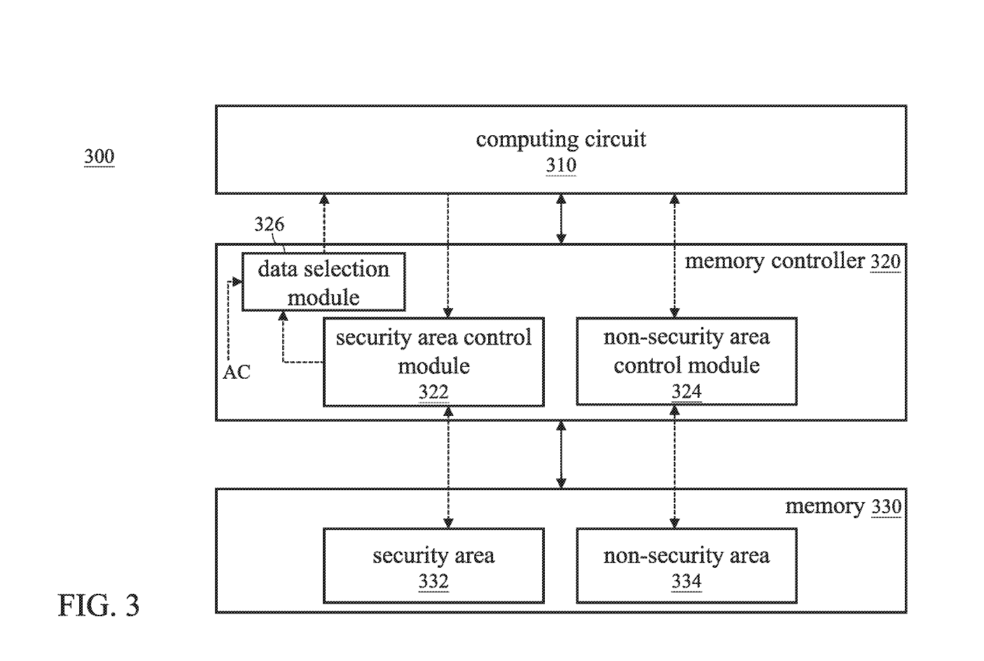

FIG. 3 is a functional block diagram of a data storage chip according to another embodiment of the present invention. In the figure, physical communication and data transmission are indicated by solid lines, and logical communication and data transmission are indicated by broken lines. The data storage chip 300 includes a computing circuit 310, a memory controller 320, and a memory 330. The computing circuit 310 may be a circuit having a program execution capability, including, but not limited to, an MCU, a microcontroller, a CPU, etc. The memory 330 is logically divided into two areas: a security area 332 and a non-security area 334. The security area 332 has a first range of memory address, the non-security area 334 has a second range of memory address, and the first range of memory address does not overlap with the second range of memory address; that is, the security area 332 and the non-security area 334 are different logic areas of the memory 330. The memory controller 320 includes a security area control module 322 and a non-security area control module 324, and a data selection module 326. The computing circuit 310 accesses the security area 332 through the security area control module 322 and accesses the non-security area 334 through the non-security area control module 324. The computing circuit 310, the memory controller 320, and the memory 330 are packaged in the same chip or a single chip which has a data storage function.

When the computing circuit 310 needs to access the memory 330, the computing circuit 310 sends out a memory access command containing a target address. The memory access command contains a write command or a read command. Depending on whether the memory access command contains the write command or the read command, the memory controller 320 either writes the data to the target address or reads the data from the target address and then transmits the read data to the computing circuit 310. The memory controller 320 determines, according to the target address in the memory access command, whether to use the security area control module 322 to access the security area 332 or to use the non-security area control module 324 to access the non-security area 334. More specifically, when determining that the target address is within the first range of memory address, the memory controller 320 uses the security area control module 322 to access the security area 332; when, on the other hand, determining that the target address is within the second range of memory address, the memory controller 320 uses the non-security area control module 324 to access the non-security area 334. In some embodiments, the security area control module 322 and the non-security area control module 324 substantially correspond to or use the same circuit but have different control logics. In other embodiments, the security area control module 322 and the non-security area control module 324 substantially correspond to or use different circuits.

When the memory access command corresponds to the write command, the security area control module 322 directly writes the data to the security area 332, and the non-security area control module 324 directly writes the data to the non-security area 334. When the memory access command corresponds to the read command, the non-security area control module 324 directly transmits the target data read from the non-security area 334 to the computing circuit 310, whereas the security area control module 322 transmits the target data read from the security area 332 to the data selection module 326 rather than directly transmits the target data to the computing circuit 310. The data selection module 326 transmits the target data or the fake data to the computing circuit 310 according to the control value AC. The fake data is different from the target data.

The control value is, for example, a register value of a certain register of the data selection module 326. For example, when the control value is a first value (e.g., 1 or 0xFF), the data selection module 326 transmits the target data to the computing circuit 310; when the control value is a second value (the second value is different from the first value, such as 0 or 0x00), the data selection module 326 does not transmit the target data to the computing circuit 310, or transmits the fake data to the computing circuit 310. That is, the memory controller 320 (more specifically, the data selection module 326) selectively transmits the target data to the computing circuit 310 according to the control value. On the other hand, the memory controller 320 (more specifically, the non-security area control module 324) accesses the non-security area 334 according to the memory access command without referring to the control value. In other words, the memory controller 320 controls the computing circuit 310's authority to read the security area 332 but does not control the computing circuit 310's authority to read the non-security area 334.

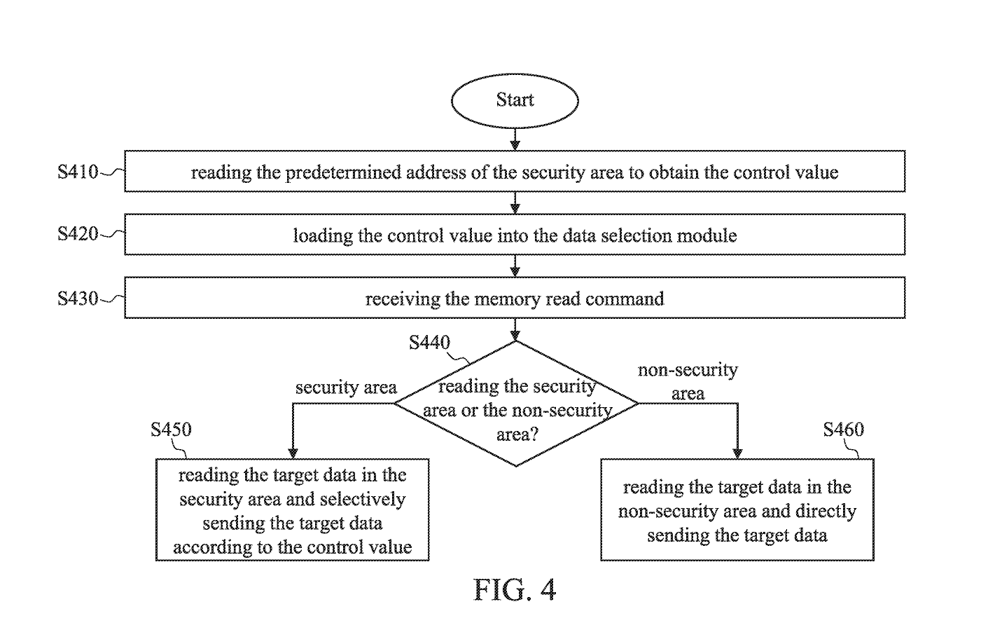

In one embodiment, the control value AC is originally stored in a predetermined address in the security area 332 and is loaded into the register of the data selection module 326 at an appropriate time. FIG. 4 is a flowchart of a data access method according to an embodiment of the present invention. The flowchart corresponds to an operation in which the computing circuit 310 reads the memory 330. First, the memory controller 320 (more specifically, the security area control module 322) reads the predetermined address of the security area 332 to obtain the control value (step S410) and then loads the control value into the register of the data selection module 326 (step S420). After receiving the memory read command from the computing circuit 310 (step S430), the memory controller 320 determines whether the target address in the memory read command corresponds to the security area 332 or the non-security area 334 (step S440). When the target address corresponds to the security area 332, the memory controller 320 (more specifically, the security area control module 322) reads the target data in the security area 332, and then the memory controller 320 (more specifically, the data selection module 326) selectively transmits the target data to the computing circuit 310 according to the control value (step S450). When the target address corresponds to the non-security area 334, the memory controller 320 (more specifically, the non-security area control module 324) reads the target data in the non-security area 334 and directly transmits the target data to the computing circuit 310 (step S460).

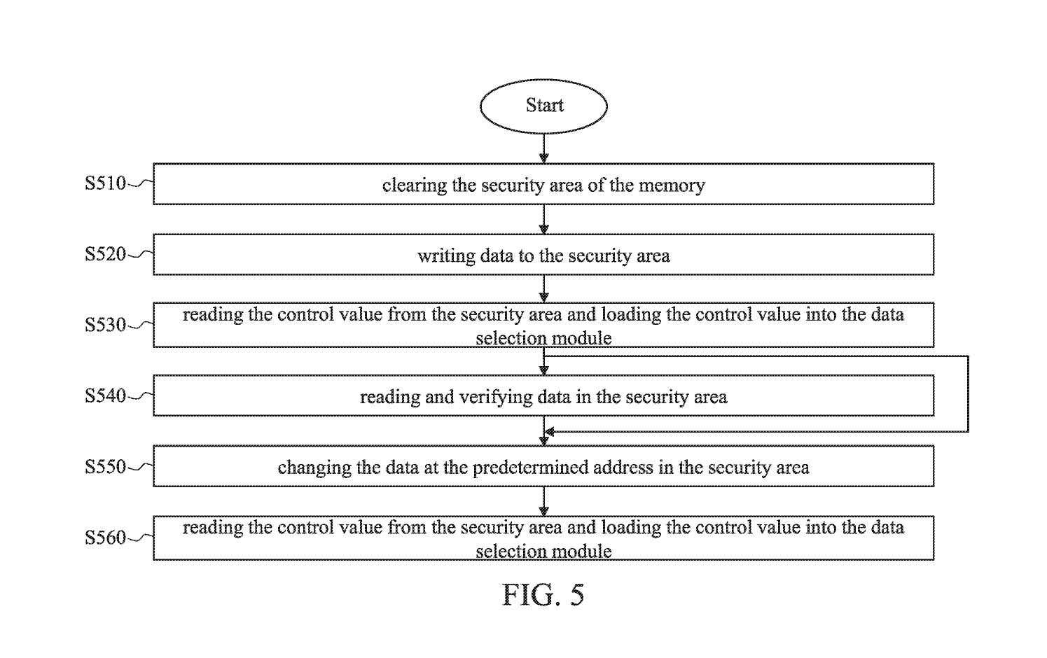

FIG. 5 is a flowchart of a data access method according to another embodiment of the present invention. The flowchart corresponds to one of the operation methods that the computing circuit 310 utilizes to update the data in the security area 332. When the computing circuit 310 needs to update the data in the security area 332, the computing circuit 310 first sends a command to clear the memory, and then the memory controller 320 (more specifically, the security area control module 322) clears the security area 332 (e.g., deletes all the data in the security area 332) according to the command (step S510). When the security area 332 is cleared, the data at the predetermined address (i.e., the control value AC) is also cleared. That is, when the data in the security area 332 is deleted, the data at the predetermined address becomes the first value (e.g., 1 or 0xFF). Next, the memory controller 320 (more specifically, the security area control module 322) writes the data provided by the computing circuit 310 to the security area 332 (step S520). It should be noted that, in step S520, the memory controller 320 (more specifically, the security area control module 322) does not write data to the predetermined address. In other words, the computing circuit 310 is not able to or not allowed to write data to the predetermined address; thus, when step S520 is completed, the data at the predetermined address is still the first value. Next, after step S520 is completed, the data storage chip 300 is restarted. During the restart of the data storage chip 300, the memory controller 320 (more specifically, the security area control module 322) reads the data at the predetermined address in the security area 332 to obtain the control value AC and loads the control value AC into the register of the data selection module 326 (step S530).

When step S530 is completed, the control value AC is the first value, which allows the computing circuit 310 to read the data in the security area 332 through the memory controller 320. The computing circuit 310 can then read the data in the security area 332 to verify whether the data has been correctly written into the security area 332 (step S540). Note that step S540 is optional. Then (after step S530 or S540 is completed), the security area control module 322 changes the data at the predetermined address in the security area 332 to a second value (the second value is different from the first value, such as 0 or 0x00) (step S550). After step S550 is completed, the data storage chip 300 is restarted. During the restart of the data storage chip 300, the memory controller 320 (more specifically, the security area control module 322) reads the data at the predetermined address in the security area 332 to obtain the control value AC and loads the control value AC into the register of the data selection module 326 (step S560). After step S560 is completed, the control value AC is the second value, meaning that reading the data in the security area 332 is restricted. Note that in this instance (the control value AC being the second value), the security area 332 can still be written; that is, the data in the security area 332 can be updated according to the flow of FIG. 5.

By dividing the memory 330 into the security area 332 and the non-security area 334, and using the data selection module 326 to determine, based on the control value, whether the data in the security area 332 shall be transmitted to the computing circuit 310, the data storage chip 300 can achieve the purpose of protect the confidential or sensitive data. Since the range of memory address corresponding to the security area 332 is not known to a malicious person, and the computing circuit 310 cannot directly access the security area 332 of the memory 330, that malicious person cannot steal the confidential data in the memory 330 by tampering with the software executed by the computing circuit 310. Moreover, since the memory 330 is packaged in the same chip as the computing circuit 310 and the memory controller 320, separating the memory 330 from the chip will damage the memory 330, which makes it impossible for a malicious person to forcibly separate the memory 330 to thereby treat the memory 330 as a stand-alone device in an attempt to access the data stored therein.

In some embodiments, the control value AC may be a one-bit data, which corresponds to the entire security area 332. In other embodiments, the control value AC may be a one-byte data, and the security area 332 may be divided into eight sub-areas, which respectively correspond to one bit of the one-byte data; in other words, the memory controller 320 can independently control whether the data in each sub-area of the security area 332 can be read by the computing circuit 310. In some embodiments, the predetermined address may be the smallest or largest logical address or physical address of the security area 332.

Because the register of the data selection module 326 and the predetermined address of the security area 332 cannot be accessed by the computing circuit 310, the security of the data in the security area 332 can be ensured. In some embodiments, the predetermined address is not known to the computing circuit 310, and, therefore, the computing circuit 310 can only access the predetermined address by controlling the memory controller 320 (more specifically, the security area control module 322) through a predetermined command. In some embodiments, the computing circuit 310 can be designed to have the following function: during the restart of the data storage chip 300, automatically issuing a command that controls the memory controller 320 (more specifically, the security area control module 322) to read the data at the predetermined address and to load the read data into the data selection module 326.

The foregoing security area control module 222/322, non-security area control module 224/324, and data selection module 326 may be implemented by hardware in cooperation with software and/or firmware. The foregoing memory may be, for example, a non-volatile memory such as a flash memory or a magnetic memory.

The security area control module 222, the non-security area control module 224, the security area control module 322, the non-security area control module 324, and the data selection module 326 can be implemented by hardware, software, and/or firmware. When these modules are implemented by software or firmware, the memory controller 220 or 320 may utilize a processor, a controller, an MCU or the like to execute program codes or instructions stored in a memory to perform the functions of each module.

Since a person having ordinary skill in the art can appreciate the implementation detail and the modification thereto of the present method invention through the disclosure of the device invention, repeated and redundant description is thus omitted. The shape, size, and ratio of any element and the step sequence of any flowchart in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data storage chip comprising:
a memory comprising a first area and a second area, wherein the first area has a first range of memory address, the second area has a second range of memory address, the first area and the second area are different logic areas of the memory, and the first range of memory address does not overlap with the second range of memory address;
a computing circuit configured to send a memory access command that comprises a target address; and
a memory controller coupled to the computing circuit and the memory and configured to access the first area or the second area of the memory according to the memory access command;
wherein when the target address is within the first range of memory address, the memory controller selectively accesses the first area according to a control value, and when the target address is within the second range of memory address, the memory controller accesses the second area; and
wherein the memory, the computing circuit, and the memory controller are packaged in a single chip.

2. The data storage chip of claim 1, wherein the memory controller comprises a first control module and a second control module, the first control module accesses the first area, the second control module accesses the second area, when the target address is within the first range of memory address and the control value indicates a first value, the first control module accesses the first area according to the memory access command, and when the target address is within the first range of memory address and the control value indicates a second value which is different from the first value, the first control module does not access the first area.

3. A data storage chip comprising:
a memory comprising a first area and a second area, wherein the first area has a first range of memory address, the second area has a second range of memory address, the first area and the second area are different logic areas of the memory, and the first range of memory address does not overlap with the second range of memory address;
a computing circuit configured to send a memory access command that comprises a target address; and
a memory controller coupled to the computing circuit and the memory and configured to access the first area or the second area of the memory according to the memory access command, the memory controller comprising:
a first control module that accesses the first area but does not access the second area;
a second control module that accesses the second area but does not access the first area; and
a data selection module coupled to the first control module and configured to selectively send the data in the first area to the computing circuit according to a control value;
wherein the first control module accesses the first area according to the memory access command when the target address is within the first range of memory address, and the second control module accesses the second area according to the memory access command when the target address is within the second memory; and
wherein the memory, the computing circuit, and the memory controller are packaged in a single chip.

4. The data storage chip of claim 3, wherein when the memory access command is a read command, and the target address is within the first range of memory address, the first control module sends the data in the first area to the data selection module.

5. The data storage chip of claim 4, wherein when the control value is a first value, the data selection module sends the data in the first area to the computing circuit, and when the control value is a second value which is different from the first value, the data selection module does not send the data in the first area to the computing circuit.

6. The data storage chip of claim 3, wherein the first control module reads a predetermined address of the first area and loads the data at the predetermined address into the data selection module to serve as the control value.

7. The data storage chip of claim 6, wherein after the first area is cleared, the data at the predetermined address is a first value, and when the control value is the first value, the data selection module sends the data in the first area to the computing circuit.

8. The data storage chip of claim 7, wherein after the first area is cleared, the first control module writes a second value to the predetermined address, and when the control value is the second value, the data selection module does not send the data in the first area to the computing circuit.

9. A data access method applied to a memory that comprises a first area and a second area, the first area having a first range of memory address, the second area having a second range of memory address, the first area and the second area being different logic areas of the memory, and the first range of memory address not overlapping with the second range of memory address, the method comprising steps of:
reading a predetermined address of the first area to obtain a control value;
receiving a memory read command that contains a target address;
accessing the first area according to the memory read command when the target address is within the first range of memory address, and accessing the second area according to the memory read command when the target address is within the second range of memory address; and
selectively sending the data read from the first area according to the control value.

10. The method of claim 9, wherein when the control value is a first value, the data read from the first area is sent, and when the control value is a second value, the data read from the first area is not sent, the method further comprising:
clearing the first area;
wherein the data at the predetermined address is the first value after the first area is cleared.

11. The method of claim 10 further comprising:
writing data in the first area after the first area is cleared; and
writing the second value at the predetermined address after the data is written.

12. The method of claim 11 further comprising:
reading the data at the predetermined address to update the control value after the second value is written to the predetermined address.
